(19) United States
(12) Patent Application Publication
(10) Pub. No.: US 2012/0185455 A1
(43) Pub. Date: Jul. 19, 2012

(54) SYSTEM AND METHOD OF PROVIDING SEARCH QUERY RESULTS

(76) Inventor: Aliaksandr Hedrevich, Draper, UT (US)

(21) Appl. No.: 13/007,536

(22) Filed: Jan. 14, 2011

(51) Int. Cl. G06F 17/30

(52) U.S. Cl. 707/706; 707/723; 707/E17.108

(57) ABSTRACT

A system and method for searching and ranking information based on consumer product reviews. A system for searching and ranking information based on consumer product reviews includes a database including information collected from consumer product reviews, a search engine connected to the database to provide search results, and a ranking module connected to the search engine for ranking the search results by relevancy, wherein the search engine is adapted to send the ranking search results to a computer device based on the product review information.

### BACKGROUND OF THE INVENTION

The present invention generally relates to the field of searching and browsing a computer network system. More specifically, the present invention relates to a system and method of searching, ranking, and presenting results based on consumer product reviews.

Present search engines allow users to access information relating to products or services based on a search query. The search engine processes the query against a database and provides the user with results that satisfy the search query. Typically, the search query contains general terms, which generate a large number of results. Unfortunately, the general terms may not be helpful in finding information that does not fall into the general description of the product. Furthermore, the user sometimes does not have knowledge of how the product has been described by other users; thus, relevant results are missed.

As can be seen, there is a need to provide a search engine that allows the user to search a database by using terms that describe a product based on other users' comments.

### SUMMARY OF THE INVENTION

In one aspect of the present invention, a system for searching and ranking information based on consumer product reviews includes a database including information collected from consumer product reviews, a search engine connected to the database to provide search results, and a ranking module connected to the search engine for ranking the search results by relevancy, wherein the search engine is adapted to send the ranking search results to a computer device based on the product review information.

In another aspect of the present invention, a method for searching and ranking information based on consumer product reviews including the steps of collecting information from the consumer product reviews, storing the information on a database, ordering the information on the database by a rank module, and displaying the ordered information based on a search query placed on a computer device.

These and other features, aspects and advantages of the present invention will become better understood with reference to the following drawings, description and claims.

### BRIEF DESCRIPTION OF THE DRAWINGS

FIG. 1 illustrates a schematic view of the system for searching and ranking information based on consumer product reviews according to an exemplary embodiment of the present invention;

FIG. 2 illustrates a flowchart diagram illustrating a method for searching and ranking information based on consumer product reviews according to an exemplary embodiment of the present invention;

FIG. 3 illustrates screenshot showing search engine results according to an exemplary embodiment of the present invention; and

FIG. 4 illustrates a screenshot showing an enlargement view of a result of FIG. 3 using the product review information.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a computer system and method for searching, ranking, and presenting results based on consumer product reviews.

Consumer product reviews may be collected by sending an e-mail to the consumer to review the product a predetermined amount of time after they make a purchase. The customer may provide the review either by replying to the e-mail or by clicking on or otherwise selecting a link in the review request which will link the customer to a form delivered over the Internet. In another embodiment, the consumer product reviews may be collected by crawling websites. Additional sources of product reviews, such as databases or reviewing enterprises, may likewise be accessed.

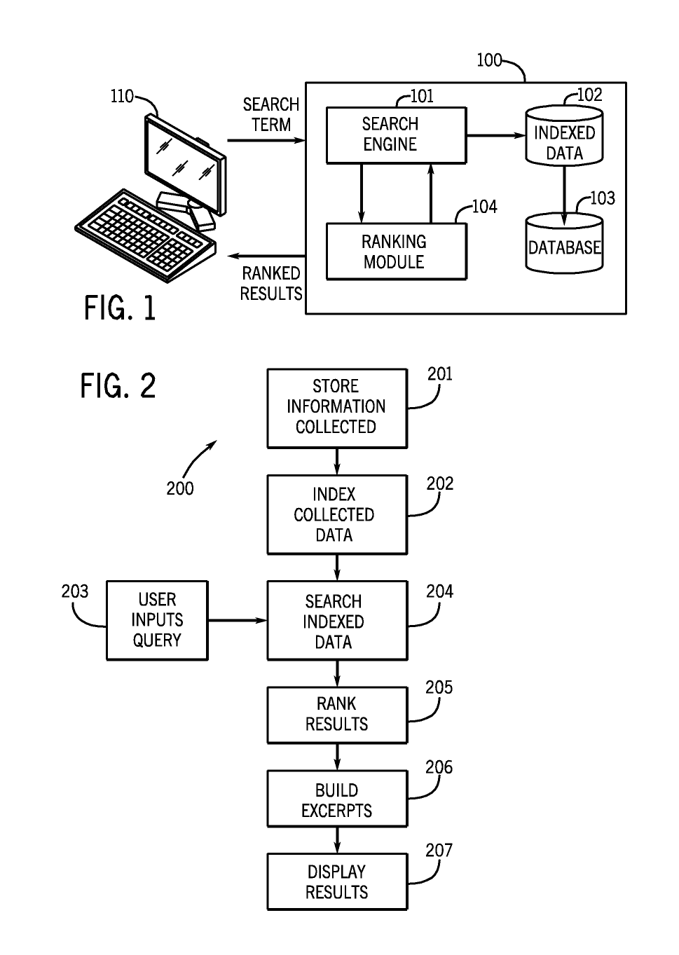

FIG. 1 illustrates a schematic view of the system for searching and ranking information 100 based on consumer product reviews according to the present invention. The system 100 may be a computer, processor or server configured to perform the storage, searching, indexing and ranking of data collected by consumers.

The system 100 may accept a search query from an ancillary computer device 110. The computer device 110 may be a personal computer, a cellular phone, a set-top-device, game consoles, or a handheld computer. A database 103 may be created with the information collected from the consumer product reviews. After collecting the product reviews, the product reviews may be stored in a database 103 and according to a product identification number (ID number). The product reviews may be sorted by a ranking module 104 before displaying the search results. In one embodiment, the collected data stored in the database 103 may be indexed by an indexer module 102. Indexing of the data may speed up and improve the returned search results. The indexer module 102 may remove general terms from the consumer product reviews to improve the speed of the search and reduce storage space used by indexed data.

The consumer may input a search query and a search engine 101 may search the indexed data for consumer product reviews matching the search query. The results returned by the search engine 101 may be ordered by the ranking module 104 so the results may be displayed by their relevancy.

The ranking module 104 may use an algorithm to assign the relevancy rank (W) to the result. In one embodiment, the product may include more than one customer review and the total relevancy rank (W) may be calculated as follows:

W=□ᵢ₌₀ⁿωᵢ

Total relevancy rank equals the sum of relevancy ranks of each review. Where w is the weight of the review i; (n−is a number of reviews)

The relevancy rank (ωᵢ) may be calculated by using different relevance ranking algorithms. In one embodiment, the relevance ranking algorithms may be calculated by using Levenshtein distance, Okapi BM25 factor, and Phrase proximity ranking algorithms.

FIG. 2 illustrates a flowchart diagram illustrating a method 200 for searching and ranking information based on consumer product reviews according to an exemplary embodiment of the present invention. The information collected from the consumer product reviews may be stored in step 201. The storage information 201 may be indexed in step 202. The indexed data may be searched in step 204 when the user places a search query in step 203. The results of the indexed data 102 may be ordered by rank in step 205 so the results may be displayed by relevancy in step 207. Excerpts may be built in step 206 to include bold or highlighted keywords to draw the consumer attention.

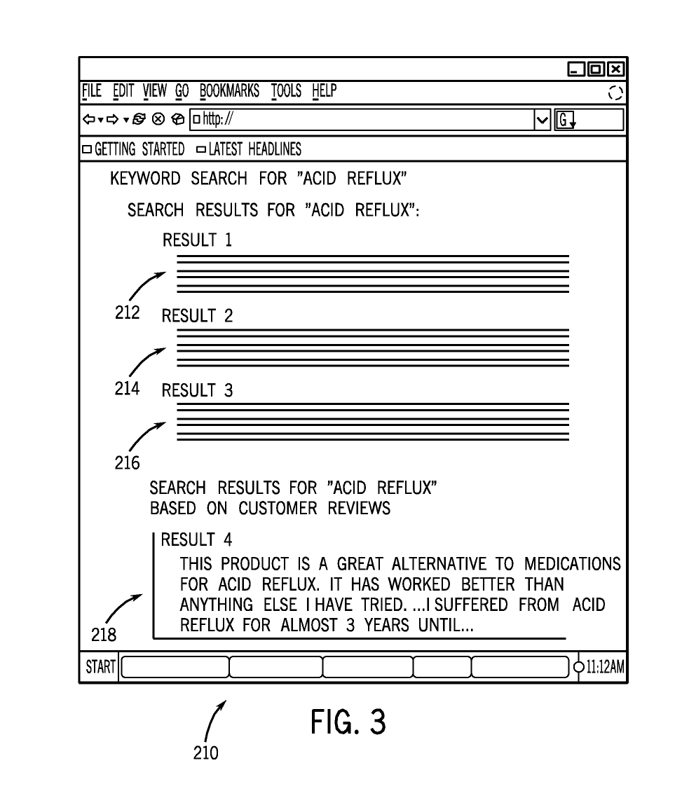

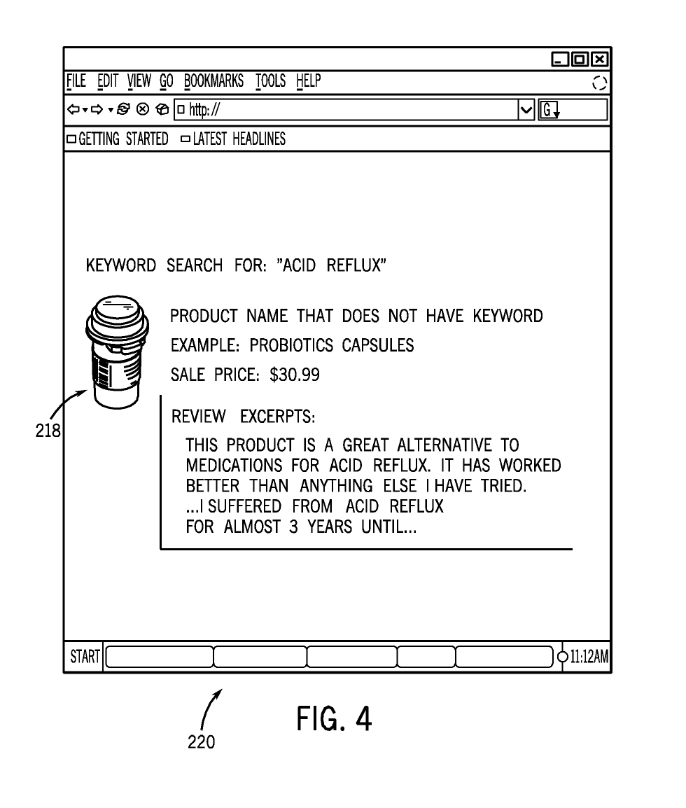

The user may browse a website to submit a search request in step 203. Upon receiving the request, the server may display the results in step 207, such as the results display shown on FIGS. 3-4, back to the user's computer.

FIG. 3 illustrates screenshot 210 showing search engine results 212, 214, 216, and 218 according to an exemplary embodiment of the present invention. In this embodiment, the search results may be displayed by their independent results.

FIG. 4 illustrates a screenshot 220 showing an enlargement view of result 218 of FIG. 3. The result 218 may include the product review information, the product name, the product picture, the product price, and users reviewed excerpts.

Consumer product reviews may be very helpful during a search query because the consumer reviews generate additional information and keywords for the product that allows the search engine to return more relevant results.

It should be understood, of course, that the foregoing relates to exemplary embodiments of the invention and that modifications may be made without departing from the spirit and scope of the invention as set forth in the following claims.

We claim:

1. A system for searching and ranking data comprising:
a database including information collected from consumer product reviews;
a search engine connected to the database configured to provide search results; and
a ranking module connected to the search engine for ranking the search results by relevancy to a search query;
wherein the search engine is adapted to send the ranked search results to a computer device based on the product review information.

2. The system according to claim 1, further comprising an indexer module connected between the database and the search engine.

3. The system according to claim 1, wherein the product reviews are stored in the database according to an identification number.

4. The system according to claim 1, wherein the computer device is selected from a personal computer, a cellular phone, a game console, or a handheld computer.

5. A method for searching and ranking search query results, the method comprising the steps of:
collecting information from consumer product reviews;
storing the information on a database;
ranking the information on the database by a rank module; and
displaying the ranked information, including the consumer product reviews, based on a search query placed on a computer device.

6. A method according to claim 6, further including building excerpts to include bold or highlighted keywords on the ranked information.

7. A method according to claim 6, further including indexing the information on the database prior to ranking the information by the rank module.
